(19) United States
(12) Patent Application Publication
(10) Pub. No.: US 2003/0231758 A1
(43) Pub. Date: Dec. 18, 2003

(54) Call center and method of operating a call center

(76) Inventors: Richard Bock, Munchen (DE); Uwe Herrmann, Ebersberg (DE)

Correspondence Address: Kevin R. Spivak, Morrison & Foerster LLP, Suite 300, 1650 Tysons Boulevard, McLean, VA, 22102, US

(21) Appl. No.: 10/348,324

(22) Filed: Jan. 22, 2003

(30) Foreign Application Priority Data
Jan. 23, 2002 (DE) 10202499.5

(51) Int. Cl. H04M 3/00; H04M 5/00; G06F 15/16; G06F 9/00

(52) U.S. Cl. 379/265.02; 709/201; 709/310

(57) ABSTRACT

The invention relates to a call center and method for operating automated call center services. The call center includes agent workstations which are connected via a telecommunications system to a public telecommunications network, whereby the agent workstations are connected via an internal communications network to one another and to at least one data server, where at least one service server is provided which is connected to the internal communications network, whereby at least one automated call center service runs at least partially and at least temporarily on the service server, and at least one service server can be connected via at least one switching computer to the public telecommunications network. According to the invention, the at least one call center service is controlled on the service server by at least one service program unit.

### CLAIM FOR PRIORITY

This application claims priority to Application No. 10202499.5 which was filed in the German language on January 23, 2002.

### TECHNICAL FIELD OF THE INVENTION

The invention relates to a call center and method for operating automated call center services.

### BACKGROUND OF THE INVENTION

Call centers are service-providing facilities for telecommunications tasks, specifically offering telephone support for customer requirements. Call centers are used in businesses, banks and insurance companies, in mail-order companies, in direct banking, in support and in many further areas in which telephone support, advice or sale is possible.

The advantage of call centers lies in the direct contact between the customer and the company. Time-consuming telephone forwarding is eliminated, along with inquiries for the correct contact and callback requests, because call centers are equipped with appropriate functions such as ACD (“Automatic Call Distribution”), EAS (“Expert Agent Selection”) and IVR (“Interactive Voice Response”).

Call centers exploit the fact that the majority of company contacts are made via the telephone switching office; in trading companies, most order processes are handled by telephone; only a small number of callers normally reach the required contact and callers hang up after a specific waiting period. Call centers eliminate these disadvantages, wherever possible, when they directly meet all customer requirements and can thereby increase customer satisfaction. These aims are achieved through the efficient use of technology, in which fast access to all relevant data, either customer data or technical data, is guaranteed through the integration of a telephone PABX system, computers and database systems.

In terms of the tasks performed, a distinction is made between call centers which handle incoming calls only, referred to as “inbound call centers”, and those which handle outgoing calls only, for example for direct marketing or new customer acquisition. Such call centers are referred to as “outbound centers”. Call center employees are referred to as “agents”.

Call centers are also increasingly used for automated (call center) services, such as routing of calls within the call center or automatic booking, ordering, etc. via the Internet.

However, one disadvantage of currently employed solutions is that a separate solution with corresponding interfaces currently has to be implemented in each case for each automated call center service. The relevant service is itself responsible for starting up components required for the relevant service. No administration of components jointly used by a plurality of services takes place, as a result of which call center services cannot be jointly administered and maintained, even if they run on the same hardware.

### SUMMARY OF THE INVENTION

One embodiment of the invention relates to a call center for operating automated call center services, comprising agent workstations which are connected via a telecommunications system to a public telecommunications network, whereby the agent workstations are connected via an internal communications network to one another and to at least one data server, where at least one service server is provided which is connected to the internal communications network, whereby at least one automated call center service runs at least partially and at least temporarily on the service server, and the at least one service server can be connected via at least one switching computer to the public telecommunications network.

Another embodiment of the invention relates to a method of operating automated call center services in a call center which comprises agent workstations which are connected via a telecommunications system to a public telecommunications network, whereby the agent workstations are connected via an internal communications network to one another and to at least one data server, where at least one service server is provided which is connected to the internal communications network, whereby at least one automated call center service runs at least partially and at least temporarily on the service server, and the at least one service server can be connected via at least one switching computer to the public telecommunications network.

The invention seeks to design the implementation of automated call center services in call centers to be more effective and substantially simpler.

According to one embodiment of the invention, the at least one call center service is controlled on the service server by at least one service program means

According to another embodiment of the invention, a new layer is introduced between an operating system and the services in the form of one or more service program unit, thereby enabling a plurality of call center services to be implemented on one hardware platform, the services then being monitored and controlled by a common instance, i.e. the service program unit.

The at least one service server is connected via data lines to the at least one switching computer. The call center according to the invention can be implemented in a particularly simple and low-cost manner if the at least one switching computer forms part of the telecommunications system of the call center.

The invention can be implemented simply and reliably if the (at least one) service program unit, which normally involves correspondingly set-up software, runs on the service server.

In order to enable the use of any given services and simple implementation of new services, the service program unit has uniform interfaces for communication with the call center services.

The interfaces are normally software interfaces.

In order to enable problem-free communication between the call center services and a remote station outside the call center, it is provided that communications components for communication between the call center services and the switching computers run at least temporarily on the service server, the switching computers then setting up the connection to the relevant remote station.

These communications components, which normally involve corresponding software, are normally provided by the service program unit, i.e. the service software.

A call center service, in the present embodiment, comprises software, however all components of the software do not necessarily have to run on the service provider platform machine, but other software components can also run on different hardware. Naturally, alternative embodiments to software, e.g. hardware, firmware, etc., may be used as readily understood by the skilled artisan.

As already mentioned, the communications components are preferably software stacks.

So that each service does not have to be started up separately and by itself, it is furthermore provided that the at least one service server is set up to start up the service software (SPP) and/or the components during a service server start-up.

These services, which can be started, stopped, restarted and ended, comprise software which runs on the service server.

Furthermore, the at least one service server is set up to initialize the started components or the service software, whereby the services register with the service software during the initialization.

In order to guarantee fail-safe operation, the components and the software can be stopped and restarted.

For the sake of simple and user-friendly operation and monitoring of the services, it is furthermore provided that the at least one service server can be connected to at least one console which is set up to start and/or stop and/or restart components and/or service software on the service server.

For the same reason, it is also provided that the at least one console is set up to indicate the status of individual call center services.

Finally, it is also favorable for the correct and problem-free operation of the call center services for the latter to be set up to transmit status messages and/or alarm messages and/or other data relating to the services or to a service server to the at least one console, and for the at least one console to be set up to receive and at least indicate these messages. The aforementioned “other data” entail, for example, data relating to the installed services, e.g. port configurations of a booking service, etc. These data are dependent on the installed service. The data are transferred in particular via a dedicated generic message interface.

The services can normally transfer generalized statuses, alarms, etc. However, different services are also able to transfer different, service-specific data to the service software. To enable this, dedicated service components (display components) are provided by the services to run on the console, to receive service-specific data and display these data on the console.

These services, which in turn can be started, stopped, restarted and ended, in turn comprise software which runs on the service server. By means of the console, these operations, such as start-up, etc., can be performed, for example, by console-operating personnel. This is favorable, for example, if a service is no longer running (correctly) and disruption to other services running in parallel is to be avoided.

Furthermore, according to a method of the invention, the at least one call center service is controlled on the service server by at least one service program unit.

### BRIEF DESCRIPTION OF THE DRAWINGS

The invention is explained in more detail below with reference to the drawings, in which:

FIG. 1 shows the basic structure of a call center according to the invention.

FIG. 2 shows the embedding of automated call center services in a call center.

FIG. 3 shows an interface diagram with the corresponding data streams.

FIG. 4 shows an exemplary implementation of an automated call center service.

### DETAILED DESCRIPTION OF THE INVENTION

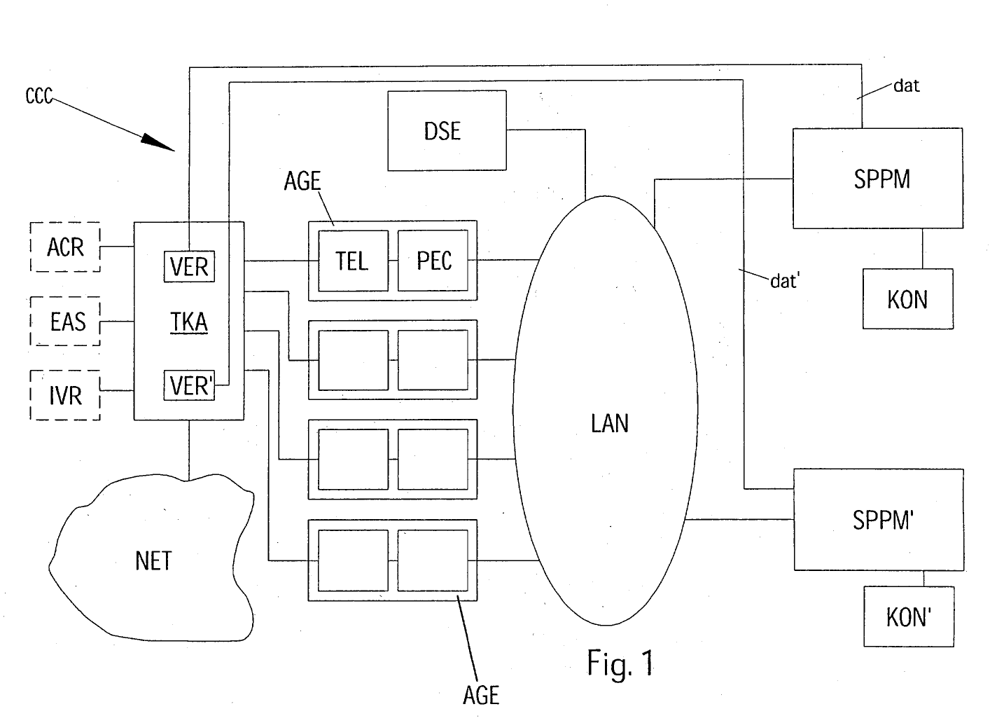

FIG. 1 shows a call center CCC which, in a conventional manner, comprises a number of agent workstations AGE which are connected via a telecommunications system, for example a PABX system TKA, to the public telephone network NET.

The agent workstations AGE normally comprise a telecommunications terminal device TEL and an input/output device, normally comprising at least one personal computer PEC. The telecommunications terminal devices TEL and the computers PEC are normally interconnected, for example by means of an ISDN card built into the computer COM.

Furthermore, the agent workstations AGE are connected via an internal network LAN to one another and to one or more data servers DSE. By means of the telecommunications system TKA, the call center offers various service features such as “Expert Agent Selection” EAS, with which telephone numbers from calling parties are analyzed and can be forwarded directly to the relevant agent, “Interactive Voice Response” IVR, involving a dialog-oriented voice system for relieving the burden of routine tasks and for queuing management in call centers, whereby IVR, in conjunction with unified messaging, enables the implementation of a voice-controlled menu, in which the user can select various options via push-buttons or voice, or “Automatic Call Distribution” ACD, etc., as already mentioned in the introduction.

According to the invention, a call center CCC of this type also has at least one service server SPPM, SPPM′, also referred to below as the service provider platform machine, on which at least one call center service DIE (= service provider), one service software SPP (= service provider platform) and one or more components KOM run.

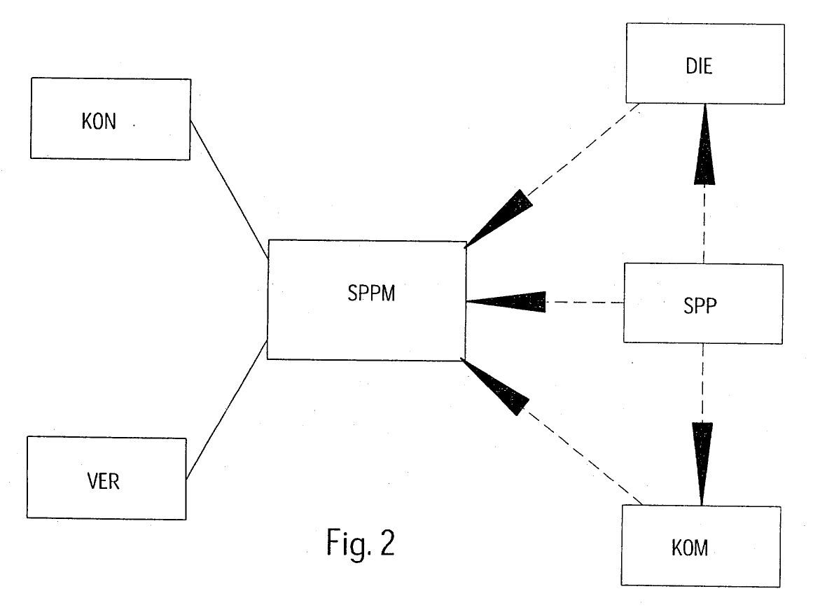

FIG. 2 shows the fundamental connection between the individual hardware and software components. The central component is the service server or service provider platform machine SPPM, SPPM′, which is connected via data lines dat, dat′ (see FIG. 1) to one or more switching computers VER, VER′, which normally form(s) part of the telecommunications system TKA. Furthermore, the service servers SPPM, SPPM′ are also connected in each case to a console KON, KON′, whereby, however, in principle only one console may also be provided for a plurality of service servers.

As shown in FIG. 2, a service software SPP runs on the service provider platform machine SPPM, along with one or more call center services DIE. One or more components KOM also run on the service provider platform machine SPPM, which, if necessary, are used by a call center service, whereby these components KOM and the services DIE themselves are administered by the service provider platform (i.e. the service software) DIE.

The switching computer VER is physically connected via data lines dat to the service provider platform machine SPPM. Communication between the service provider platform machine SPPM, and therefore also the call center services DIE, and the switching computer VER and therefore other terminal devices which communicate via the public network NET with the call center CCC is enabled using the (communications) components KOM which, as already described, run on the service provider platform machine SPPM. These components are, for example, software stacks.

The components KOM are normally protocols which enable communication between the switching computer VER and the service server SPPM.

Furthermore, the service server SPPM is also connected to a console KON, referred to as a maintenance console. This is a device with which control and monitoring tasks can be carried out for different devices in the call center, in particular for the service provider platform machine SPPM. Electrical and electronic devices are carried out. A person with special access rights, referred to as a system operator, is normally responsible for a console of this type.

The console KON is responsible, inter alia, for starting, stopping and restarting the components KOM running on the service provider platform machine SPPM, and the service software DIE likewise running thereon.

Furthermore, the at least one console KON, KON′ is set up to indicate the status of individual call center services DIE, so that information is constantly available with reference to which the functioning or any problems with the running of the service software DIE can be tracked. Furthermore, status messages, alarm messages and other data, as already explained in more detail above, relating to the services DIE or the service server SPPM, SPPM′, generated by the call center services DIE, can be received by the console KON, KON′, where they are then output, for example on a display, if necessary following prior analysis.

In terms of automated services, other services are also planned in addition to the aforementioned services, e.g. time and charge provider via e-mail and/or SMS, statistics provider, booking provider, CSTA provider (“Computer Supported Telecommunications Application”), etc.

A time/charge provider, for example, sends the customer charge information relating to calls which have been made; a statistics provider collects call statistics from the switching computer. A “CSTA” provider controls call routing. A booking provider enables bookings to be made via the Internet. The bookings are then transferred via the provider to the switching system.

However, this list is in no respect complete, and the invention can of course be applied to other unlisted services, and similarly to services which do not yet exist.

One advantage of the invention is that, due to the new infrastructure of the call center CCC according to the invention, a new, automated call center service DIE can now be simply introduced into the existing configuration in that the service supports the corresponding interfaces to the service provider platform SPP, i.e. to the service software. This new service can then be started, ended, restarted and monitored therewith. Its status, and also messages such as alarm messages, etc., can also be transmitted.

So that service-specific data can also be displayed, a corresponding software component DKO is provided by the relevant service, which is then connected by the maintenance console KON in runtime—the maintenance console therefore activates this (display) component DKO if service-related data arrive at the console—and is then used.

To allow the invention to function, the service software SPP provides uniform interfaces which can then be used by call center services. This enables the implementation of new call center services without the need to make modifications to the service provider platform or the maintenance console.

According to the invention, it is now possible for a range of call center services to run on one platform SPPM, which range of services are jointly controlled, coordinated and monitored.

One such software provider platform machine SPPM will normally suffice for one call center CCC, but it can also be provided for various reasons that additional platform servers SPPM′ are also incorporated into the call center CCC, as also shown in FIG. 2. According to FIG. 2, each platform server SPPM, SPPM′ has its own console KON, KON′, but it can also be provided for only one console to monitor all platform servers SPPM, SPPM′.

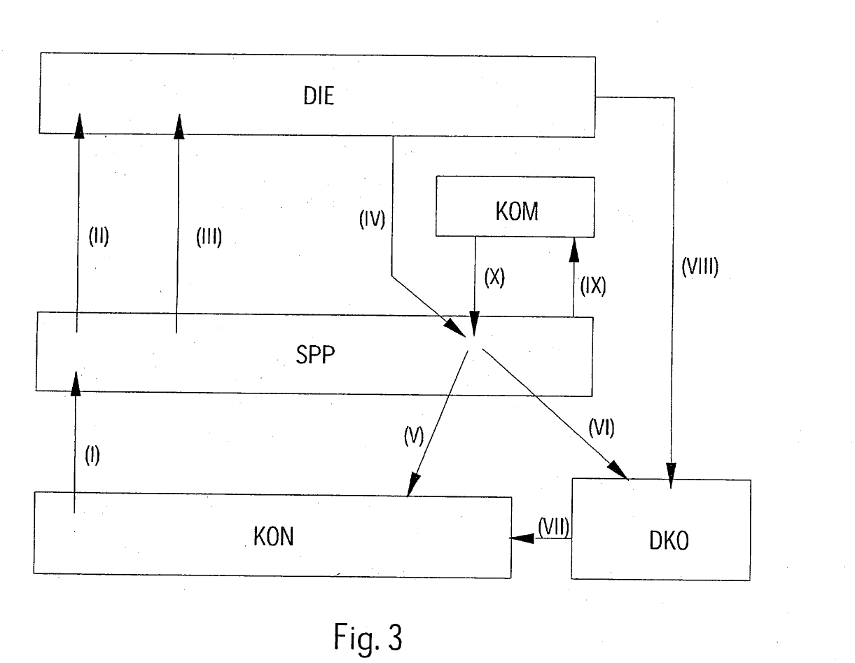

To provide a clearer understanding of the processes, FIG. 3 also shows a diagram of the interfaces between the individual software programs, which will also be briefly examined in more detail below:

(I): Commands to start, end and restart the service provider platform SPP are transferred from the console KON to the service server.

(II): The service provider platform SSP starts, ends and restarts the call center services DIE.

(III): These call center services are furthermore monitored by the service provider platform SPP.

(IV): Statuses, alarms and service-specific monitoring data are transferred to the service provider platform SPP.

(V): Statuses and alarms are displayed on the console KON.

(VI), (VII): The service-specific monitoring data are received and displayed by the console KON via corresponding (display) components DKO.

(VII), (VIII): The service-specific monitoring data can also be directly received and displayed by the console KON, without the diversion via the service provider platform SPP, via corresponding (display) components DKO.

(IX): Furthermore, communications components KOM (as already explained in more detail above) are also started, ended and restarted, initialized and monitored by the service provider platform SPP, and

(X): these components report specific component data to the service provider platform SPP.

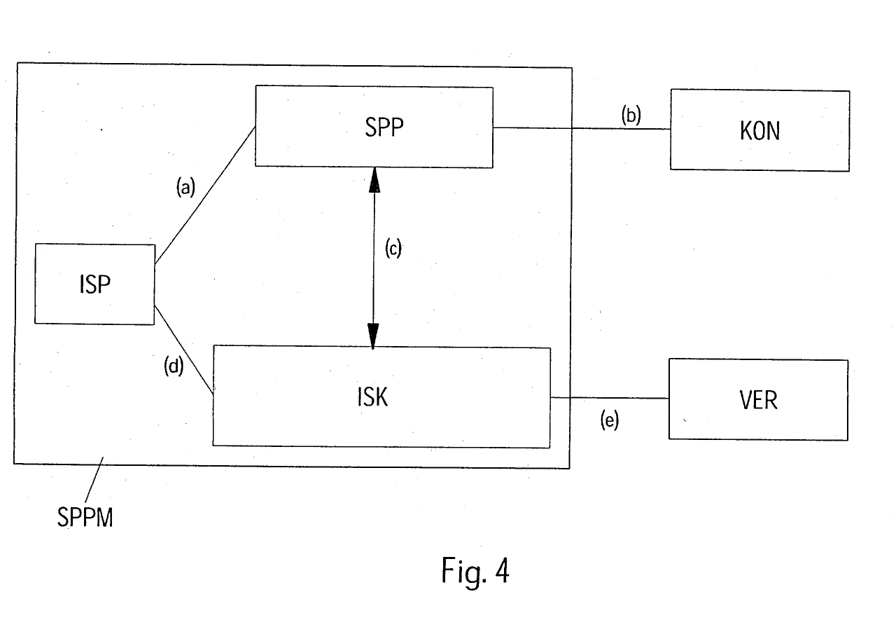

Finally, FIG. 4 also shows a specific example of an implementation of a call center service ISP (“Internet Service Provider”).

The special automated call center service ISP is started, ended, restarted and monitored by the service provider platform SPP, and status messages, alarms and servicespecific monitoring data are received (a) and forwarded to a maintenance console KON (b), where they are then output.

Furthermore, specific components ISK are started, initialized, ended, restarted and monitored by the service provider platform SPP (c) and, via these communications components ISK, which enable two-way data transport, the service ISP can set up, use and then clear down a data connection (d), whereby this connection is then implemented by the component ISK via the switching computer VER (e), so that communication with a remote station can take place via a telecommunications network which is connected to the switching computer VER, and the call center service ISP.

What is claimed is:

1. A call center for operating automated call center services, comprising:
agent workstations which are connected via a telecommunications system to a public telecommunications network, wherein the agent workstations are connected via an internal communications network to one another and to at least one data server;
at least one service server connected to the internal communications network; and
at least one automated call center service running at least partially and at least temporarily on the service server, wherein
the at least one service server is configured to be connected via at least one switching computer to the public telecommunications network, and
the at least one call center service is controlled on the service server by at least one service program unit.

2. The call center as claimed in claim 1, wherein the at least one service server is connected via data lines to the at least one switching computer.

3. The call center as claimed in claim 1, wherein the at least one switching computer forms part of the telecommunications system of the call center.

4. The call center as claimed in claim 1, wherein the at least one service program unit runs on the service server.

5. The call center as claimed in claim 1, wherein the at least one service program unit has uniform interfaces for communication with the call center services.

6. The call center as claimed in claim 1, wherein the interfaces are software interfaces.

7. The call center as claimed in claim 1, wherein communications components for communication between the call center services and the switching computers run at least temporarily on the service server.

8. The call center as claimed in claim 7, wherein the communications components are provided at least partially by the at least one service program unit.

9. The call center as claimed in claim 7, wherein the communications components are software stacks.

10. The call center as claimed in claim 1, wherein the at least one service server is set up to start up the service software and/or the components during a service server start-up.

11. The call center as claimed in claim 10, wherein the at least one service server is set up to initialize the started components or the service software.

12. The call center as claimed in claim 1, wherein the components and the software can be stopped and restarted.

13. The call center as claimed in claim 1, wherein the at least one service server is configured to be connected to at least one console which is set up to start and/or stop and/or restart components and/or service software on the service server.

14. The call center as claimed in claim 13, wherein characterized in that the at least one console is set up to indicate the status of individual call center services.

15. The call center as claimed in claim 13, wherein the call center services are set up to transmit status messages and/or alarm messages and/or other service-specific data relating to the services or to a service server to the at least one console, and the at least one console is set up to receive and at least indicate these messages.

16. The call center as claimed in claim 14, wherein dedicated service components are provided by the services which run on the console and enable the reception of service-specific data on the console.

17. A method of operating automated call center services in a call center, comprising:
connecting agent workstations via a telecommunications system to a public telecommunications network, wherein the agent workstations are connected via an internal communications network to one another and to at least one data server;
providing at least one service server which is connected to the internal communications network; and
running at least one automated call center service at least partially and at least temporarily on the service server, wherein the at least one service server is configured to be connected via at least one switching computer to the public telecommunications network, and
the at least one call center service is controlled on the service server by at least one service program unit.

18. The method as claimed in claim 17, wherein one of the at least one service program units is used which runs on the service server.

19. The method as claimed in claim 17, wherein the at least one service program unit has uniform interfaces for communication with the call center services.

20. The method as claimed in claim 17, wherein the interfaces are software interfaces.

21. The method as claimed in claim 17, wherein communications components for communication between the call center services and the switching computers run at least temporarily on the service server.

22. The method as claimed in claim 21, wherein the communications components are provided at least partially by the at least one service program unit.

23. The method as claimed in claim 21, wherein the communications components are software stacks.

24. The method as claimed in claim 17, wherein the service software and/or the components are started up by the at least one service server during a service server start-up.

25. The method as claimed in claim 24, wherein the started components or the service software are initialized by the at least one service server.

26. The method as claimed in claim 17, wherein the components or the software can be stopped and restarted.

27. The method as claimed in claim 17, wherein the at least one service server is configured to be connected to at least one console, by which the components on the service server and/or the service software can be started and/or stopped and/or restarted.

28. The method as claimed in claim 27, wherein the status of individual call center services is indicated by the at least one console.

29. The method as claimed in claim 27, wherein status messages and/or alarm messages and/or other service-specific data relating to the services or to a service server are transmitted by the call center services to the at least one console and are received and at least indicated by the at least one console.

30. The method as claimed in claim 28, wherein dedicated service components are provided by the services which run on the console and enable the reception of service-specific data on the console.
